(19) United States
(12) Patent Application Publication
(10) Pub. No.: US 2006/0185004 A1
(43) Pub. Date: Aug. 17, 2006

(54) Method and system for single sign-on in a network

(75) Inventors: Yu Song, Milpitas, CA (US); Alan Messer, Los Gatos, CA (US)

Correspondence Address: MYERS DAWES ANDRAS & SHERMAN, LLP, 19900 MACARTHUR BLVD.,, SUITE 1150, IRVINE, CA, 92612, US

(73) Assignee: Samsung Electronics Co., Ltd., Suwon City (KR)

(21) Appl. No.: 11/056,219

(22) Filed: Feb. 11, 2005

(51) Int. Cl. G06F 17/30

(52) U.S. Cl. 726/8

(57) ABSTRACT

A user identity authentication system in a network is implemented on a device or multiple devices in the network. The authentication system employs a map that translates device-specific user IDs to system-wide user IDs and vice versa. A user is authenticated on a device with a device-specific authentication method. Once a user is authenticated on a specific device, a device-specific user ID is translated into a system-wide user ID. This system-wide user ID is further translated into other device-specific user IDs such that other devices can authenticate the user based on the device-specific user IDs. Further, if a device is not capable of authenticating a user, it can delegate authentication to another device or a proxy.

### FIELD OF THE INVENTION

The present invention relates generally to user authentication for access-to-devices in a network, and more particularly, to user authentication on multiple, heterogeneous devices and appliances in a home network.

### BACKGROUND OF THE INVENTION

Several conventional approaches for user authentication to access devices in a network exist. The most popular approach is to use a centralized authentication server to store user authentication information, such as username/password, such that a user can log on with any client devices. The user authentication information provided by the user is transmitted to the authentication server for verification. Once authenticated, the user can access computing resources on different devices directly without further user verification on each individual device. A slightly modified approach for centralized server is to have an authentication server to access those resources on behalf of the client device.

However, a centralized authentication approach assumes that devices in a network have the same authentication method. In a networked enterprise environment, username/password can be assumed because every computer can accept username/password. However, that is not true for a home network where devices are heterogeneous in their authentication capabilities and methods.

Instead of a centralized authentication server, other conventional approaches store authentication information that is needed to access a client device on the client device itself. To access resources on a device, the user presents the device-specific user authentication information to the device and the device authenticates the user using device-specific methods. In such approaches, no centralized authentication server and unified user information exist. Compared to the centralized authentication server approach, authentication security is improved in that a compromise of authentication on one device does not affect the security on other devices. However, such approaches require a user to have access to the device that stores the authentication information for authentication purposes. The user cannot authenticate himself/herself on any given device.

Another conventional approach attempts to provide single sign-on (SSO) for multiple computing devices, each of which has its own user ID, with a map from device-specific ID to a system user ID such that once a user is logged onto a device, the same user can be automatically authenticated by the translation between the system user ID and device user ID. A modified version for such a decentralized SSO is called federated ID system, where there is no system-wide user ID. Each device contains a map that maps the device-specific user ID on that device to device-specific user IDs on other trusted devices. The list of trusted devices allows those users who are authenticated by the trusted device to be automatically authenticated on this device. However, these approaches assume that each device is capable of containing a user ID for a user. Further, the federated ID system is not flexible in that a device cannot authenticate a user if the device does not have authentication capability.

### BRIEF SUMMARY OF THE INVENTION

The present invention addresses the above shortcomings. In one embodiment the present invention provides an authentication system and method in a distributed system, such as a home network, that allows single sign-on (SSO) to authenticate a user over heterogeneous devices in the network. The present invention also allows a user to have a single sign-on (SSO) on multiple, heterogeneous devices and appliances in a home network within an application session and/or across multiple application sessions. The SSO system and method hide the different authentication methods that are device-specific from users and client applications, allowing SSO with different authentication methods on heterogeneous devices.

In one version, the SSO system (and method) is implemented on a device or multiple devices in the home network. The SSO system employs a map that translates device-specific user IDs to system-wide user IDs and vice versa. A user is authenticated on a device with a device-specific authentication method. Once a user is authenticated on a specific device, a device-specific user ID is translated into a system-wide user ID. This system-wide user ID is further translated into other device-specific user IDs such that other devices can authenticate the user based on the device-specific user IDs. Further, if a device is not capable of authenticating a user, it can delegate authentication to another device or a proxy.

Compared to conventional approaches where authentication information is stored on a dedicated client device, the present invention does not require a user to have such a device that is for authentication purpose only. By contrast, the present invention allows a user to authenticate himself/herself on any given device. Once authenticated on one device, a user can be authenticated on any devices in a home environment when the user wishes to access resources on those devices. The present invention is advantageous over conventional approaches that use device-specific user ID, because such conventional approaches assume that each device is capable of containing a user ID for a user, whereas in the present invention, a device may not have capability to have user ID, but it can delegate other devices to authenticate on its behalf.

Further, compared to the conventional federated user ID system, the present invention is more flexible in that a device can authenticate a user if the device has the authentication capability; otherwise, it can delegate the authentication to another device to authenticate on its behalf. The delegate can be a device that has the authentication capability or a software proxy module that includes an authentication method. In addition, mapping user IDs among multiple devices are centralized. This is advantageous over the conventional federal ID system where a device contains a partial mapping between the device to other trusted devices, because it allows easy setup in a central place instead of requiring user to setup for each device.

Other embodiments, features and advantages of the present invention will be apparent from the following specification taken in conjunction with the following drawings.

### BRIEF DESCRIPTION OF THE DRAWINGS

FIG. 1 shows an example functional block diagram of a network in which an embodiment of access control according to the present invention is implemented.

FIG. 2 shows an example functional block diagram of an authorization system according to an embodiment of the present invention.

FIG. 3 shows an example functional block diagram of an authorization system according to another embodiment of the present invention.

FIG. 4 shows an example functional block diagram of an authorization system according to another embodiment of the present invention.

FIG. 5 shows an example flowchart of example authorization steps implemented in the system of FIG. 2.

FIG. 6 shows an example flowchart of example authorization steps implemented in the system of FIG. 3.

FIG. 7 shows an example flowchart of example authorization steps implemented in the system of FIG. 4.

### DETAILED DESCRIPTION OF THE INVENTION

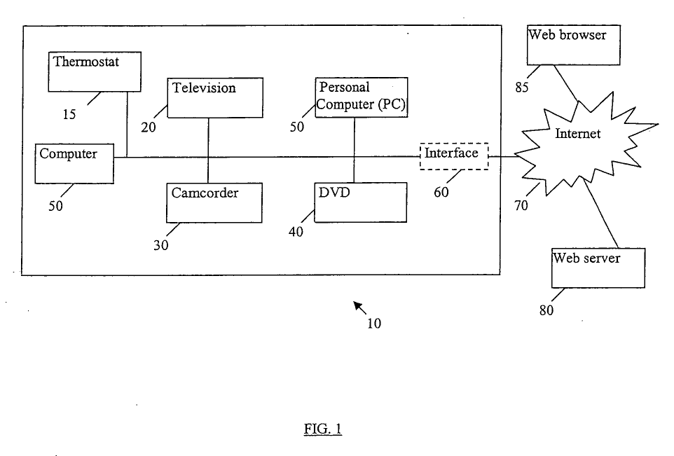

Referring to FIG. 1, an example network such as a home network 10 includes multiple computing devices and appliances, such as TV 20, camcorder 30, DVD 40, conventional computing devices, such as PCs 50, which can be connected to the internet 70 via an optional interface 60 for communication with a web server 80 and a web browser 85. In the network 10, each computing device and appliance is heterogeneous in its computability and access methods. For example, a general purpose home personal computer 50 has enough computational power for authenticating a user while a thermostat is programmed to control the heating and cooling facility in the home and has little computation power. Usage of an application in the home network 10 usually utilizes multiple devices and appliances in the network 10. For example, playing a DVD movie includes connecting a DVD player to a TV, connecting TV to a home theater system, and browsing the DVD movie list to find a desired movie to play. To allow such usage, a authentication SSO system/method is provided in the network 10 such that a user is authenticated on each device before he/she is authorized to access resources on these devices. The SSO system does not burden the user with multiple sign-ons for each device he/she would like to use.

The SSO system and method according to an embodiment of the present invention allows a SSO in a session or across multiple sessions in an application. A session comprises a set of devices that is grouped together to provide certain services in an application. A user who uses the application needs to physically sign on with a device that he/she interacts with, and remotely sign on with other devices that the applications needs. For example, playing a DVD movie in a computer on a TV application requires a user to physically signs on with the TV, and subsequently sign on with the computer in order to play a DVD movie. The present invention automates the remote sign-on process for a user. In one example, this does not mean that the user can walk up to the computer during DVD playing session and use it without authentication. Such action is considered as the user wants to start another application on the computer, and requires another authentication.

The example SSO system (and method) is implemented on a device or multiple devices in the network 10. The SSO system employs a map that translates device-specific user IDs to system-wide user IDs and vice versa. A user is authenticated on a device with a device-specific authentication method. Once a user is authenticated on a specific device, a device-specific user ID is translated into a system-wide user ID. This system-wide user ID is further translated into other device-specific user IDs such that other devices can authenticate the user based on the device-specific user IDs. Further, if a device is not capable of authenticating a user, it can delegate authentication to another device or a proxy.

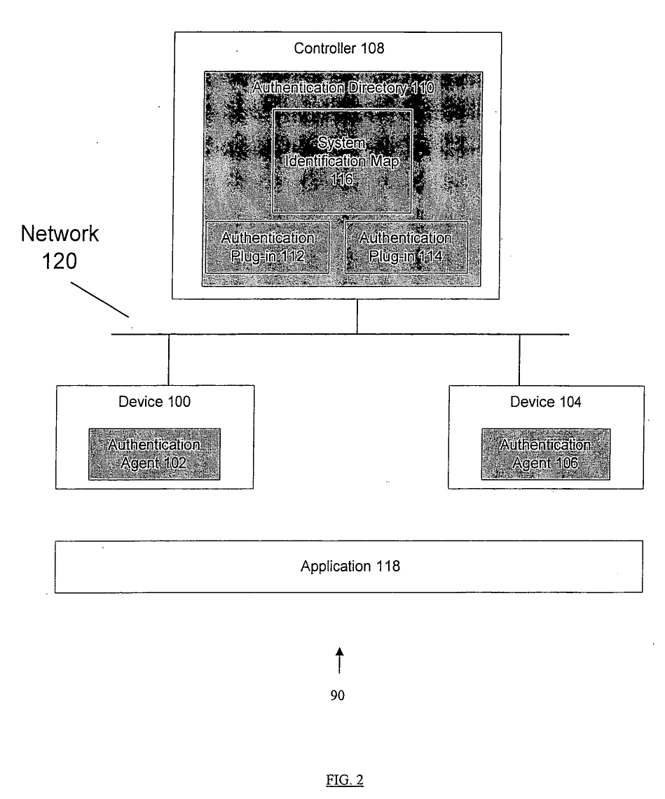

In one version, the SSO system is implemented among multiple devices, each of which may have its own authentication mechanism. For example, a computer allows a user to type username/password. A security door allows a user to swipe a badge. FIG. 2 shows a functional block diagram of an example SSO system 90 according to an embodiment of the present invention, comprising: a device 100 that has its own authentication agent 102; a second device 104 that has its own authentication agent 106; and a controller (software) module 108. The controller can run on a separate device or can run on device 100 or device 104. Devices 100, 104 and the device that hosts the controller are connected by the network 120.

The devices 100 and 104 can be any devices in the network 10, such as security-aware UPnP devices that contain device-specific authentication methods (e.g., device security ID). The controller software module 108 is implemented on a processing device such as an UPnP control point with security console (e.g., a PC 50 in network 10, FIG. 1). The controller 108 includes a system-wide user identification map 116 implemented in software, and an authentication directory 110 implemented in software, which includes multiple authentication plug-ins 112 and 114 also implemented in software, each of which corresponds to authentication agents 102 and 106, respectively. The system-wide user identification map 116, maps the device-specific user IDs from each device in the network 10 to a system-wide user ID. The authentication plug-in 112 can communicate with authentication agent 102 with a device-specific protocol. Likewise, the authentication plug-in 114 can communicate with the authentication agent 106 in a device-specific protocol. The authentication agent 102 includes a device-specific authentication method. For example, the authentication agent 102 uses username/password, and the authentication agent 106 uses personal badge. In this example, the controller 108 comprises a software module that as noted, can be hosted by a single computing device, such as a home computer 50 in FIG. 1, or can be distributed among multiple computing devices in the network 10. A distributed application 118 initiates on both device 100 and device 104, both of which require user authentication before the application can run. In this example, all devices are connected with different network technologies, such as Ethernet, wireless LAN (e.g., IEEE 802.11x), etc.

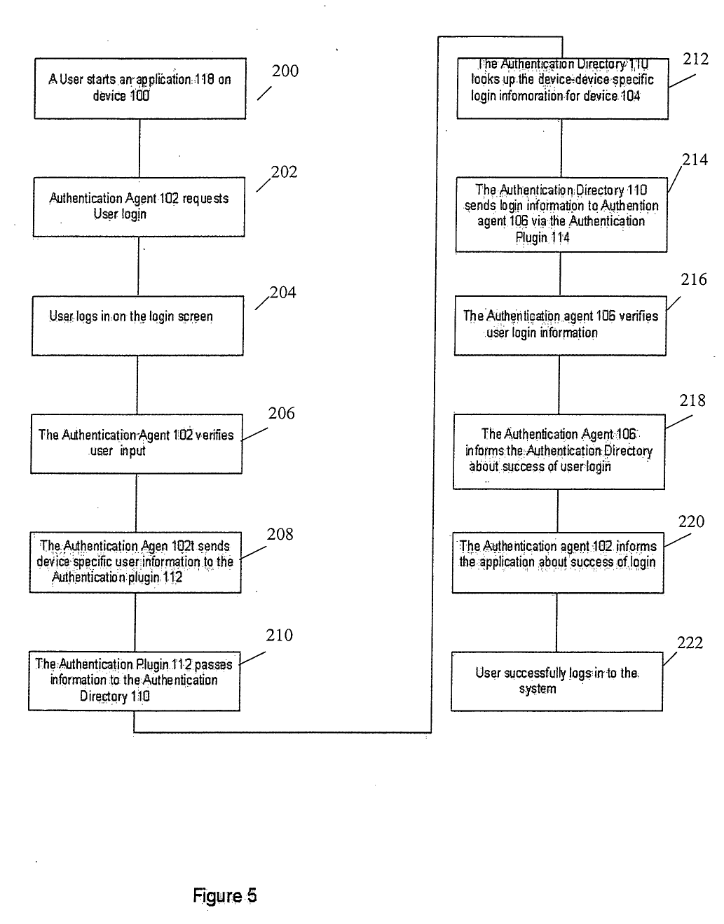

An example step-by-step operation of the SSO system 90 of FIG. 2 is described below in conjunction with steps 200-222 shown in FIG. 5.

Step 200: A user starts the application 118 on the device 100.

Step 202: The authentication agent 102 in device 100 requests for the user's authentication information using the. device-specific method.

Step 204: The user responds to the request and the response is received by the authentication agent 102.

Step 206: The authentication agent 102 verifies the user's input and confirms that the user is an authenticated user.

Step 208: The authentication agent 102 sends the device-specific user ID to the authentication plug-in 112.

Step 210: The authentication agent 102 passes the device-specific user ID to the authentication directory 110. The authentication directory 110 maps the device-specific user ID to a system-user ID using the system ID map 116.

Step 212: The authentication directory 110 retrieves device-specific ID for device 104 from the system ID map 116 and sends it to the authentication plug-in 114.

Step 214: The authentication plug-in 114 sends the device-specific ID to authentication agent 106 in the device 104.

Step 216: The authentication agent 106 verifies and confirms the user ID.

Step 218: The authentication agent 106 informs the application 118 about the verification result.

Step 220: The authentication agent 102 informs the application 118 about the verification result.

Step 222: The authentication agent 102 sends “OK” to the authentication plug-in 114, wherein the authentication plug-in 114 passes “OK” to the authentication directory 110, and as a result, the user is so authenticated among multiple devices with SSO.

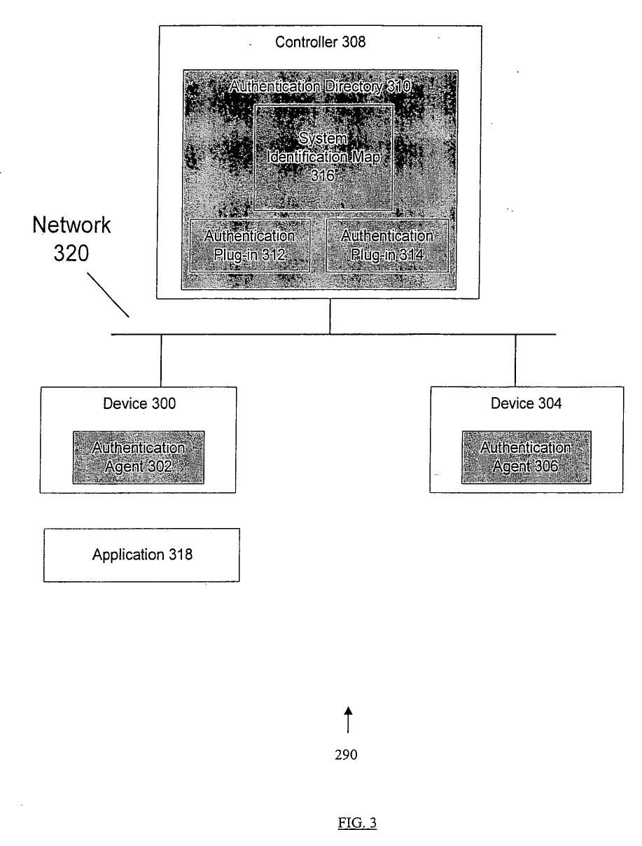

In a second embodiment, the present invention provides another SSO system (and method) implemented on multiple devices in the network 10 of FIG. 1, some of which devices may not have their own authentication mechanisms. For example, a thermostat may not have its own authentication mechanism. Instead, these devices rely on other devices to authenticate a user for them. FIG. 3 shows an example functional block diagram of said SSO system 290 according to the second embodiment of the present invention, comprising: a device 300 that has its own authentication agent 302; a second device 304 that has its own authentication agent 306; a software controller module 308. The controller can run on a separate device or can run on device 300 or device 304. Devices 300, 304 and the device that hosts the controller are connected by the network 320.

The device 300 can be any device in the network 10 that does not have authentication method, such as an UPnP device that does not have UPnP security stack. The device 304, however, can be any device that can authenticate a user. For example, the device 304 can be an UPnP security-aware device that has a device security ID. Whenever a user wants to access services on the device 300, the authentication agent 302 directs the authentication process to authentication agent 306 on device 304. The controller 308 runs on a processing device in the network 10, such as an UPnP control point with security console (e.g., a PC 50 in network 10). The controller 308 includes an authentication directory 310 which includes a system-wide user identification map 316, and multiple authentication plug-ins 312 and 314, each of which corresponds to authentication agents 302 and 306, respectively. The system-wide user identification map 316 maps the device-specific user IDs from each device in the network 10 to a system-wide user ID. The authentication plug-in 312 can communicate with the authentication agent 302 in a device-specific communication protocol. Likewise, the authentication plug-in 314 can communicate with the authentication agent 306 with a device-specific communication protocol. The authentication agent 302 does not have its own authentication method. Instead, it delegates the device 304 to authenticate on its behalf. In this example, the controller 308 is implemented as a software module that, as noted, is hosted by a single computing device, such as a home computer 50, or can be distributed among multiple computing devices in the network 10. An application 318 runs on device 300 that requires user authentication before application can run. In this example, all devices are connected with different network technologies, such as Ethernet, wireless LAN (e.g., IEEE 802.11x), etc.

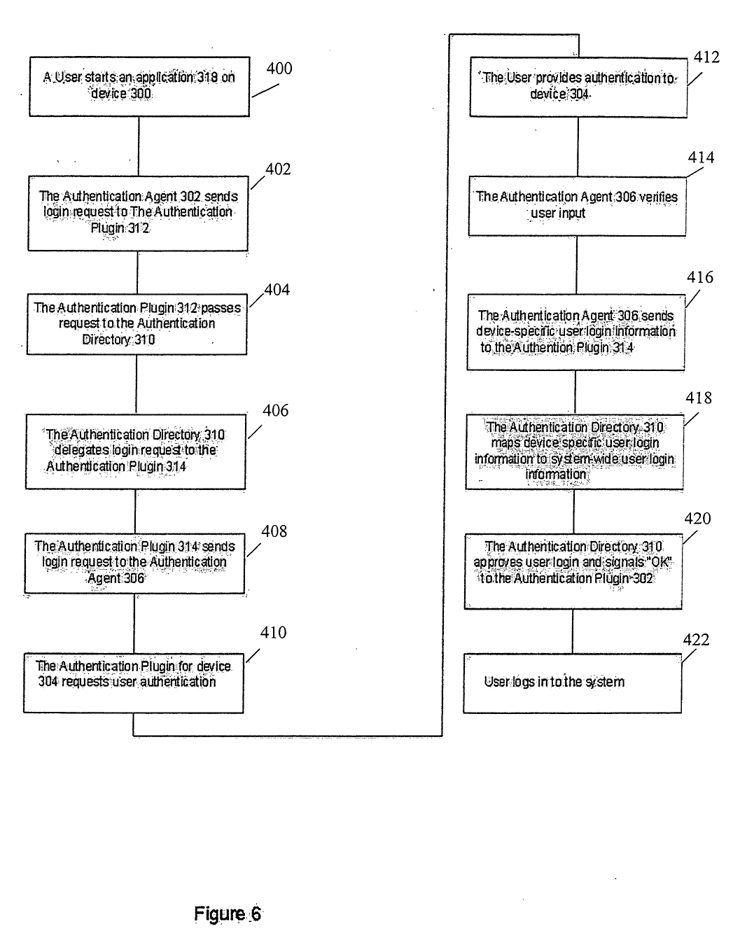

An example step-by-step operation of the SSO system 290 of FIG. 3 is described below in conjunction with steps 400-422 shown in FIG. 6.

Step 400: A user starts application 318 on the device 300 (e.g., thermostat 15, FIG. 1).

Step 402: The authentication agent 302 does not have its own authentication method. It sends an authentication request to the authentication plug-in 312. The request includes a delegation message that device 300 asks the device 304 to authenticate on its behalf.

Step 404: The authentication plug-in 312 passes the request to the authentication directory 310.

Step 406: The authentication directory 310 extracts delegation information from the request and passes the request to the authentication plug-in 314.

Step 408: The authentication plug-in 314 sends the authentication request to the authentication agent 306 in the device 304.

Step 410: The authentication agent 306 asks the user for user authentication information, using device-specific method for device 304.

Step 412: The user inputs (provides) authentication information.

Step 414: The authentication agent 306 verifies and confirms user login information.

Step 416: The authentication agent 306 sends device-specific user ID to the authentication plug-in 314.

Step 418: The authentication agent 314 asks the authentication directory to map the device-specific ID to the system-wide ID.

Step 420: The authentication directory sends “OK” message to the authentication plug-in 312.

Step 422: The authentication plug-in 312 sends “OK” message back to the authentication agent 302, wherein the authentication agent 302 authenticates the user, and the user is so authenticated and is able to use the application on the device with SSO.

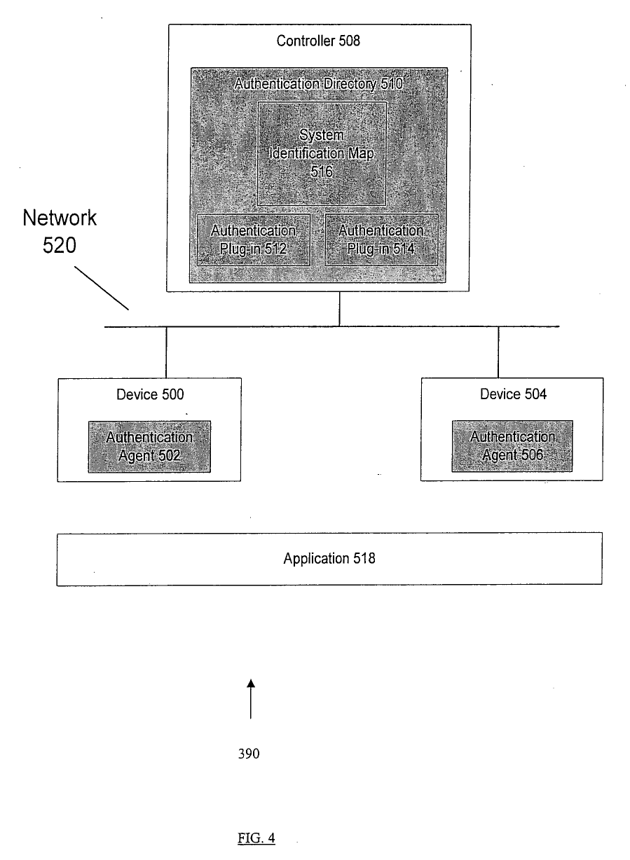

In a third embodiment, the present invention provides another SSO system (and method) implemented multiple devices in the network 10 of FIG. 1, some of which devices may not have their own authentication mechanisms. For example, a thermostat does not have its own authentication mechanism. Instead, these devices rely on their corresponding authentication plug-ins to authenticate users on their behalves. FIG. 4 shows an example functional block diagram of said SSO system 490 according to the third embodiment of the present invention, comprising: a device 500 that has an authentication agent 502; a second device 504 that has an authentication agent 506; and a software controller module 508. The controller can run on a separate device or can run on device 500 or device 504. Devices 500, 504 and the device that hosts the controller are connected by the network 520.

The device 500 can be any device in the network 10 (FIG. 1) that does not have an authentication method. Instead, the device 500 relies on other devices in the network 10 to authenticate on its behalf. For example, an UPnP device that does not have UPnP security stack relies on a UPnP control point with security console to authenticate on its behalf. The device 504, however, can be a device with an authentication method, such as an UPnP security-aware device. The software controller 508 runs on a processing device, such as UPnP control point with security control (e.g., a PC 50 in FIG. 1). The software controller 508 includes an authentication directory 510 which includes a system-wide user identification map 516, and multiple authentication plug-ins 512 and 514, each of which corresponds to authentication agents 502 and 506, respectively. The system-wide user identification map 516 maps the device-specific user IDs from each device in the network 10 to a system-wide user ID. The authentication plug-ins 512 can communicate with the authentication agent 302 in a device-specific protocol. However, the authentication agent 502 is not able to authenticate users, instead, it relies on the authentication plug-in 512 to authenticate user on its behalf. The authentication plug-in 514 communicates with the authentication agent 506 with a device-specific communication protocol. The authentication agent 506 can authenticate user with a device-specific communication method. In this example, as noted, the controller 308 is implemented as a software module that can be hosted by a single computing device, such as a home computer 50 (FIG. 1), or it can be distributed among multiple computing devices in the network 10. An application 518 is a distributed application that runs on device 500 and 504, which requires user authentication before application can run. In this example, all devices are connected with different network technologies, such as Ethernet, wireless LAN (e.g., IEEE 802.11x), etc.

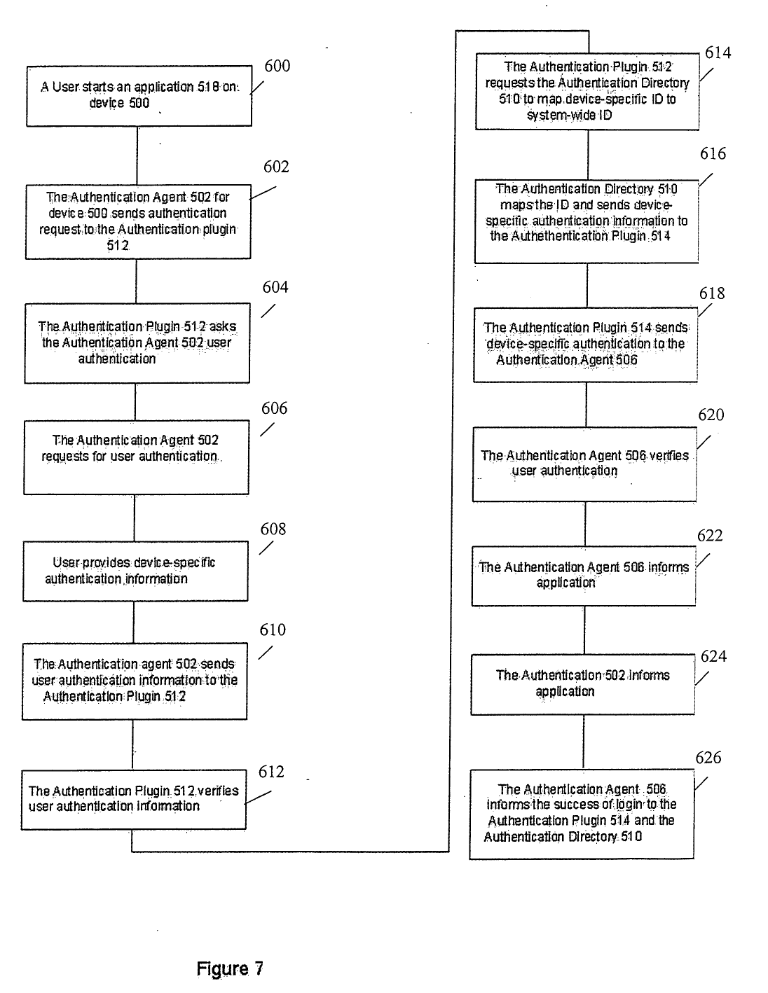

An example step-by-step description of the SSO system 390 of FIG. 4 is described below in conjunction with steps 600-626 shown in FIG. 7.

Step 600: A user starts the application 518 on devices 500 and 504.

Step 602: The authentication agent 502 sends an authentication request to the authentication plug-in 512.

Step 604: The authentication plug-in 512 asks the authentication agent 502 for user authentication.

Step 606: The authentication agent 502 asks the user for authentication information.

Step 608: The user logs in on the device 500, providing the authentication information (i.e., device-specific user ID).

Step 610: The authentication agent 502 sends device-specific user authentication information to the authentication plug-in 512.

Step 612: The authentication plug-in 512 verifies and confirms the user authentication.

Step 614: The authentication plug-in 512 asks the authentication directory 510 to map device-specific user ID to a system ID from the system ID map 516.

Step 616: The authentication directory maps the system user ID to a device-specific user ID and sends to the authentication plug-in 514.

Step 618: The authentication plug-in 514 sends the device-specific user ID to the authentication agent 506.

Step 620: The authentication agent 506 verifies and confirms the user.

Step 622: The authentication agent 506 informs the application 518 that the user has been verified.

Step 624: The authentication agent 502 informs the application 518 that the user has been verified.

Step 626: The authentication agent 506 sends “OK” message to the authentication plug-in 514, the authentication plug-in 514 sends “OK” the authentication directory 510, and the user is so authenticated on both devices and is able to use the application with SSO.

As those skilled in the art will recognize, the present invention is not limited to the above example embodiments. In a first alternative embodiment of the present invention, the authentication directory is distributed over multiple controller software modules. Each software controller module runs on a separate apparatus. For example, there may be multiple UPnP control points with separate security consoles. Each UPnP control point includes a portion of the authentication directory. Each portion of authentication directory can be either disjoint or overlapped in its content. In the case of disjoint authentication directories, the distributed authentication directories form a complete virtual authentication directory. In this embodiment of the present invention, the distributed controllers coordinate and synchronize such multiple directories to ensure they are consistent for the user. In case of overlapped authentication directories, the distributed controllers coordinate among themselves such that the multiple authentication directories form a complete and consistent virtual authentication directory. If an entry in the virtual directory changes, all entries in distributed authentication directories that correspond to the entry are updated. As those skilled in the art will recognize, there are various mechanisms that can be used for consistency update. One example method can be that of master/slave approach where one copy of an overlapped authentication directory is designated as a master on which the update is always first performed; and other overlapped portions of distributed directory are designated as slaves to which the master propagates the updates.

In a second alternative embodiment of the present invention the SSO system includes multiple replications of the authentication directory. Each copy of the authentication directory is contained in a separate controller that runs on a separate apparatus. The replications coordinate among themselves to keep a consistent view on the authentication directory. As those skilled in the art will recognize, various mechanisms can be employed to keep consistency. One example method can be master/slave where a master copy of the authentication directory is always first updated, and any changes are subsequently propagated to slave copies.

Compared to conventional approaches where authentication information is stored on a dedicated client device, the present invention does not require a user to have such a device that is for authentication purpose only. By contrast, the present invention allows a user to authenticate himself/herself on any given device. Once authenticated on one device, a user can authenticated on any devices in a home environment when the user wishes to access resources on those devices. The present invention is advantageous over conventional approaches that use device-specific user ID, because such conventional approaches assume that each device is capable of containing a user ID for a user, whereas in the present invention, a device may not have capability to have user ID, but it can delegate other devices to authenticate on its behalf.

Further, compared to the conventional federated user ID system, the present invention is more flexible in that a device can authenticate a user if the device has the authentication capability; otherwise, it can delegate the authentication to another device to authenticate on its behalf. The delegate can be a device that has the authentication capability or a software proxy module that includes an authentication method. In addition, mapping user IDs among multiple devices are centralized. This is advantageous over the conventional federal ID system where a device contains a partial mapping between the device to other trusted devices, because it allows easy setup in a central place instead of requiring user to setup for each device.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures above according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method for single sign-on (SSO) user authentication among multiple devices in a network of devices, one or more of the devices including a device-specific authentication control, comprising the steps of:
authenticating a user on a device having a device-specific authentication control based on a user provided device-specific user ID;
once the user is authenticated on a specific device, translating the device-specific user ID into a network-wide user ID; and
translating the network-wide user ID into another device-specific user ID;
wherein that other device can authenticate that user based on the device-specific user ID for that other device.

2. The method of claim 1, further comprising the steps of utilizing a map for translating device-specific user IDs to network-wide user IDs and vice versa.

3. The method of claim 1 wherein the step of authenticating a user on a device having a device-specific authentication control further includes the steps of:
in a device having a device-specific authentication control, requesting device-specific user ID from the user; and
verifying the device-specific user ID using the device-specific authentication control in that device.

4. The method of claim 3 wherein the step of translating the device-specific user ID into a network-wide user ID further includes the steps of:
mapping the device-specific user ID to a network-wide user ID using a system ID map.

5. The method of claim 4 wherein the step of translating the network-wide user ID into other device-specific user IDs further includes the steps of:
retrieving a device-specific ID for another device from the system ID map.

6. The method of claim 5 further comprising the steps of:
authenticating the retrieved device-specific ID in the other device using the device-specific authentication control in that other device, wherein that other device authenticates the user based on the device-specific user ID.

7. The method of claim 1, further comprising the steps of:
if a device is not capable of authenticating a user, then delegating authentication to another device for authenticating the user.

8. The method of claim 7, wherein the step of delegating authentication to another device for authenticating the user further includes the steps of:
delegating authentication to a device having a device-specific authentication control for authenticating the user.

9. The method of claim 8, further comprising the steps of:
the device having device-specific authentication control for authenticating the user, requesting device-specific user ID from the user; and
verifying the device-specific user ID using the device-specific authentication control in that device.

10. The method of claim 1 further comprising the steps of:
providing SSO user authentication in a session or across multiple sessions in an application.

11. The method of claim 1 further comprising the steps of:
providing said other device-specific user to said other device;
said other device using its device-specific authentication control to authenticate the user based on the provided device-specific user ID for that device.

12. A system for user authentication in a network of multiple devices, one or more of the devices including a device-specific authentication control, the system comprising:
an authentication agent in a device that authenticates a user based on a user provided device-specific user ID, using a device-specific authentication control for that device;
a controller that, once the user is authenticated, translates the device-specific user ID into a network-wide user ID, and translates the network-wide user ID into another device-specific user ID;
wherein that other device can authenticate that user based on the device-specific user ID for that other device, providing single sign-on (SSO) user authentication among multiple devices.

13. The system of claim 12 wherein the controller utilizes a map for translating device-specific user IDs to network-wide user IDs and vice versa.

14. The system of claim 12 wherein the authentication agent authenticates the user by requesting device-specific user ID from the user, and verifying the device-specific user ID using a device-specific authentication control.

15. The system of claim 14 wherein the controller translates the device-specific user ID into a network-wide user ID by mapping the device-specific user ID to a network-wide user ID using a system ID map.

16. The system of claim 15 wherein the controller translates the network-wide user ID into other device-specific user IDs by retrieving a device-specific ID for another device from the system ID map.

17. The system of claim 12 wherein if a device is not capable of authenticating a user, the device delegates authentication to another device for authenticating the user.

18. The system of claim 17 wherein the delegating device delegates authentication to another device having a device-specific authentication control for authenticating the user.

19. The system of claim 18 wherein the device having device-specific authentication control for authenticating the user, requests device-specific user ID from the user and verifies the device-specific user ID using the device-specific authentication control in that device.

20. The system of claim 12 wherein the controller provides said other device-specific user to said other device and said other device uses its device-specific authentication control to authenticate the user based on the provided device-specific user ID for that device, providing single sign-on (SSO) user authentication among multiple devices.

21. A network comprising:
multiple devices, one or more of the devices including a device-specific authentication control;
an authentication agent in a device that authenticates a user based on a user provided device-specific user ID, using a device-specific authentication control for that device;
a controller that, once the user is authenticated, translates the device-specific user ID into a network-wide user ID, and translates the network-wide user ID into another device-specific user ID;
wherein that other device can authenticate that user based on the device-specific user ID for that other device, providing single sign-on (SSO) user authentication among multiple devices.

22. The network of claim 21 wherein the controller utilizes a map for translating device-specific user IDs to network-wide user IDs and vice versa.

23. The network of claim 21 wherein the authentication agent authenticates the user by requesting device-specific user ID from the user, and verifying the device-specific user ID using a device-specific authentication control.

24. The network of claim 23 wherein the controller translates the device-specific user ID into a network-wide user ID by mapping the device-specific user ID to a network-wide user ID using a system ID map.

25. The network of claim 24 wherein the controller translates the network-wide user ID into other device-specific user IDs by retrieving a device-specific ID for another device from the system ID map.

26. The network of claim 21 wherein if a device is not capable of authenticating a user, the device delegates authentication to another device for authenticating the user.

27. The network of claim 26 wherein, the delegating device delegates authentication to another device having a device-specific authentication control for authenticating the user.

28. The network of claim 27 wherein the device having device-specific authentication control for authenticating the user, requests device-specific user ID from the user and verifies the device-specific user ID using the device-specific authentication control in that device.

29. The network of claim 21 wherein the controller provides said other device-specific user to said other device and said other device uses its device-specific authentication control to authenticate the user based on the provided device-specific user ID for that device, providing single sign-on (SSO) user authentication among multiple devices.
